(19) United States
(12) Patent Application Publication
(10) Pub. No.: US 2004/0215507 A1
(43) Pub. Date: Oct. 28, 2004

(54) Fully funded reward program

(76) Inventors: Roger A. Levitt, Terry Hills (AU); Gary J. Smith, Wahronega (AU); Peter R. Aynsley, Blacktown (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/189,859

(22) Filed: Jul. 3, 2002

(51) Int. Cl. G06F 17/60

(52) U.S. Cl. 705/14

(57) ABSTRACT

Fully funded reward program that rewards businesses that purchase goods and services from member merchants by depositing a portion of the purchase price in a bank account which may only be used to fund travel for the business. A method includes establishing a network of sellers and buyers in which the buyers receive a sales based reward and the sellers pay a sales based commission to an administrator. The administrator is unaffiliated with either the buyers or the sellers. The sales based commission is divided between a buyer component, which becomes the sales based reward, and an administrative component. The buyer component is deposited into a segregated reward bank account such that the balance in the reward bank account is fully funded.

### BACKGROUND

1. Field of the Invention

This invention relates to the field of reward programs. More specifically, the invention relates to a system and method for rewarding businesses, associations, groups and the like that purchase goods and services from participating merchants by depositing a portion of the purchase price in a bank account which may be used to fund travel for the entities.

2. Background

Many kinds of reward programs exist. The most common is the frequent flyer program. Individuals who make flight purchases, as well as other purchases, earn points which may be used by the individual earner to obtain airline travel. However, the businesses on whose behalf the individual may be flying do not benefit from this kind of reward program. In addition, these reward programs have blackout dates for flights as well as other undesirable restrictions.

Another kind of reward program may be associated with credit card usage. In one such program, a consumer is provided an annual rebate amounting to a very small percentage of all purchases made with the credit card. Another credit card usage reward program provides a consumer with a single point for each dollar spent with the particular credit card. In this program, the consumer may then redeem the points for travel with either a specified travel agent or with a particular airline, depending on the reward program. As above, if the credit card is being used for business purposes, the business receives no benefit from the points which are earned by individual users, even though the individual user of the credit card receives a benefit.

### BRIEF DESCRIPTION OF THE DRAWINGS

The invention described herein is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 illustrates a computer networked environment in which the embodiments of the reward program methods and systems described herein may be implemented.

FIG. 2 illustrates the transactions between participants in the reward program methods and systems described herein.

FIG. 3 illustrates a generalized flow of actions taken by participants according to the reward program methods and systems described herein.

FIG. 4 illustrates the flow of actions taken when a business registers to become a member of the rewards program according to the methods and systems described herein.

FIG. 5A illustrates the flow of actions taken when an individual of a member business makes a purchase from a participating merchant according to the reward program methods and systems described herein.

FIG. 5B is a flow diagram showing routing of funds in an electric point of sale funds transfer according to one embodiment of the invention.

FIG. 6A illustrates the flow of actions taken when purchasing travel from a nominated travel agent according to the reward program methods and systems described herein.

FIG. 6B is a flow diagram illustrating flow in the event that a member seeks to cancel travel previously booked through the rewards program.

FIGS. 7A and 7B illustrate an embodiment of a virtual merchant mall.

### DETAILED DESCRIPTION

Businesses purchase a variety of good and services from many different supplying merchants. Businesses may make a purchasing decision based on various factors, including the quality of the good or service provided and the price of the good or service. Other considerations may include payment terms, shipping rates and methods, etc. Many business have little or no loyalty to a particular seller, and buy solely based on price, delivery time or other factors. Many businesses have a large amount of travel expenses. Travel expenses are typically the third largest controllable expense for most businesses. Reduction of travel expenses may therefore significantly improve a business' bottom line. The systems and methods described herein provide a reward program to serve as an incentive for businesses to frequent participating sellers to receive sales based rewards which may, in one embodiment, be used to reduce travel expenses. Significantly, in various embodiments, the reward may be earned for payment of business expenses, business procurement, or both.

To motivate businesses to direct their purchases to participating merchants, member businesses are provided a sales based reward in the form of a deposit of a percentage of purchases made from participating merchants into a reward program bank account which, in one embodiment, is shared by all member businesses and maintained and managed by an auditor unaffiliated with either the reward program administrator or the participating merchants. Although the bank account is opened by the reward program, only authorized individuals affiliated with the member business are provided control of the transfer of funds out of the member rewards bank account. The member rewards bank account is managed by an unaffiliated third party such as an accountant, an escrow agent, a trustee and/or other third party auditing methods or entities. In this way, member businesses are ensured that their earned reward will not be depleted by the reward program administrator should the reward program fall on difficult times or cease doing business. While in one embodiment, a single rewards account is physically maintained at the bank, each member's share, transaction history, etc. is separately maintained and accessible by the member at the reward program center. In one embodiment, a member business receives rewards from the merchants based on a percentage of the monetary value of purchases made by the business from a participating seller. In one embodiment, the member business may use the balance in the member rewards bank account solely for purchasing travel. In one embodiment, the travel may only be purchased from a travel agent nominated by the reward program. To receive the sales based reward, an individual affiliated with a member business need only provide a program identification number when making a purchase. The business may purchase goods and services from sellers by any means at the business' disposal, including by bank check, credit card, electronic fund transfer, Internet e-commerce, bank wire, automated teller machine (ATM) card, etc.

By participating in this reward program network, merchants are provided an increased and/or steady stream of customers and a concomitant increase in revenue. In one embodiment, the merchant is required to pay a participation contribution to the reward program administrator in the form of a sum amounting to a designated percentage of gross sales to member buyers. In another embodiment, the contribution is a one time payment for original business from a member buyer. The designated participation contribution to be paid by member merchants varies depending on the arrangements made between the reward program administrator and the merchant. The participation fee may vary depending on the kind of good or service provided by the merchant. Some example participation fees follow: restaurants 25%; office supplies 15%; travel agents 2%; computer hardware 10%; etc. The kinds of merchants who may participate in the program are extensive, and include, for example: local, cellular and long distance telephone providers; electrical, petroleum gas and natural gas providers; truck and automobile dealers; magazine and newspaper publishers; and virtually any provider of a good or service that a person, business or other entity may require. These merchants are motivated to pay the participation contribution to increase their customer base and their revenue stream because of a resulting reduction in marketing and other customer acquisition costs. Because buyers are attracted to sellers by virtue of the sellers' participation in the reward program, the merchant may reduce or possibly eliminate investing in other advertising and marketing beyond the participation contribution. A benefit to participating merchants is that no sums are expended in advance of the increased customer traffic; only after a transaction with a member business is conducted is the merchant participation contribution paid.

Another benefit to participating merchants is increased customer loyalty and customer retention. Businesses initially attracted to participating merchants to obtain a fully funded reward will continue to transact business with participating merchants to grow their member rewards bank account balance. That participating merchants may be the exclusive provider of a particular good or service within a region and/or the program as a whole also increases return customers and loyalty.

To obtain business participation in the reward program described herein, the reward program administrator advertises and otherwise markets the program to businesses. The marketing includes informing and educating businesses that a certain percentage reward based on regularly made purchases of goods and services will be deposited into a fully funded business reward bank account which the business may use to buy travel from an assigned travel agent when purchases are made from participating merchants. Because of the advertising and other marketing conducted by the rewards program, the participating merchants will have a resultant increase in customers.

The reward program administrator may provide and maintain an extensive advertising and marketing campaign to promote the reward program. As such, the marketing expenses of participating merchants are reduced or, potentially, eliminated. The vast reduction in marketing expenses to participating merchants contributes to motivating the merchant to participate in the reward program. Sums that would typically go toward the merchant marketing its goods and services are available for payment of a participation contribution to be paid to the reward program. This permits significantly higher reward percentages than in traditional reward programs where the reward comes directly from the bottom line.

The reward program is funded by extracting a designated percentage from the merchant participation fee to pay for marketing, administration, etc. The remainder of the merchant participation fee is used to fund the reward program bank account of member businesses. In one example, company AAA buys $1,000 worth of telephone equipment from merchant BBB. The reward program may require the merchant to provide a 10% participation fee based on this sale, amounting to $100. Of this participation fee, the reward program may allocate 60% to the buyer as a reward and 40% to cover reward program administration expenses. So, in this example, of the $100, $60 is transferred to the business' member rewards bank account, and $40 is transferred to a reward program administration bank account. In this example, buyers of telephone equipment would be enticed to purchase from this seller to receive a 6% reward. The 60/40 allocation of reward to administration fee from the participation contribution is only an example, other allocations may be made.

Businesses are motivated to join the reward program to receive as a reward a percentage of regularly made purchases. The reward may vary depending on the kind of purchase made. Some example rewards follow: restaurants 15%; office supplies 10%; travel 1%; computer hardware 5%; etc. In addition, some merchants may incentivize Internet purchases by offering a greater reward for Internet purchases than for purchases by other means, such as by facsimile or in person. For example a business may earn for purchasing copier paper a 10% reward on-line and 8% reward if purchased in person. Other incentive plans may also be included in the reward program.

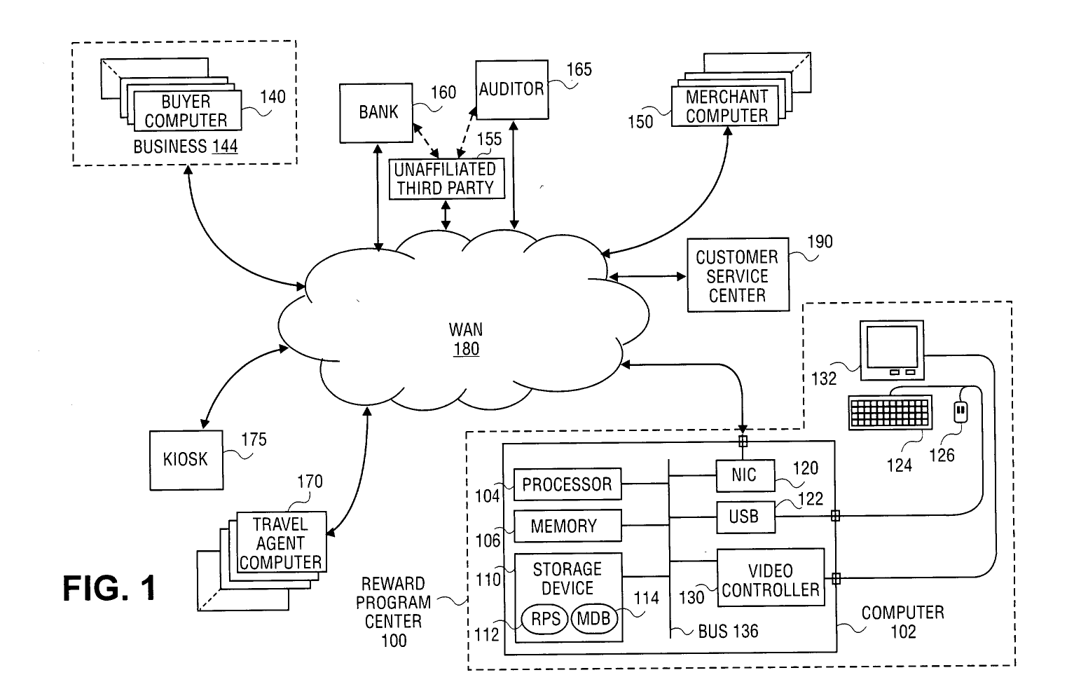

FIG. 1 illustrates a computer networked environment in which the embodiments of the reward program methods and systems described herein may be implemented. At the heart of the methods and systems described herein is a reward program center (RPC) 100. In one embodiment, the methods described herein may be implemented as software referred to as reward program software (RPS) 112. The RPS may be executed by a computer such as computer 102. Computer 102 may be any computer that can execute software programs. Computer 102 generally has features and components commonly found in server computers. In one embodiment, computer 102 includes processor 104 and memory 106. Processor 104 may be any computer processor, and memory 106 may be any random access memory (RAM) or other readable and writeable memory device. Processor 104 executes the RPS utilizing memory 106. Information, including the RPS may be read from and/or written to storage device 110. Storage device 110 may be any device by which a machine may read from a machine readable medium including, but not limited to, a magnetic disk drive such as a hard disk drive, a magnetic tape device such as a digital audio tape (DAT) device, an optical disk drive such as a readable and writeable compact disk (CDRW) drive and a readable and writeable digital versatile disk drive (DVD), stick and card memory devices, silicon devices such as electronically erasable programmable memory (EEPROM) and read only memory (ROM) devices, etc. that may be internal, such as storage device 110 and, in other embodiments, directly coupled, accessible locally or remotely via a network, and accessible via electrical, optical, acoustical or other form of propagated signals (e.g., carrier waves, infrared signals, digital signals, etc.). In one embodiment, storage device 110 may be a plurality of disk drives comprising a disk array or other configuration.

The processor may communicate instructions to video controller 130 to display text, images, etc. on display monitor 132. Video controller 130 may be any video graphics controller, and display monitor 132 may be any display monitor, including, but not limited to, a cathode ray tube (CRT) display monitor and a thin film transistor (TFT) display screen. An RPC user may access computer 102 via any computer input device, such as, for example, keyboard 124 and mouse 126 which are coupled to the processing unit by, in one embodiment, Universal Serial Bus (USB) controller 122.

Computer 102 also includes at least one network interface controller 120 which allows for communication with a wide area network (WAN) 180 such as the Internet. As used herein, WAN is deemed to include the Internet, public switched telephone networks (PSTN), satellite networks, or any other network covering a substantial geographical area. In various embodiments, information may be received through NIC 120 via land lines such as T1 lines, T3 lines, coaxial cable, Ethernet, twisted-pair, fiber optic such as a Synchronous Optical Network (SONET), or other physically present connection. In other embodiments, the connection via NIC 150 may be wireless in the form of microwave, satellite, radio wave and the like. The format of the data sent by and received by the RPC may be any data format including, for example, the Transmission Control Protocol (TCP), Universal Datagram Protocol (UDP), Internet Protocol (IP) Packets, etc.

In one embodiment, the RPS may include Internet web site software that provides for the communicating and display of Internet web pages on remote computers and remote computing devices. The Internet software may be written in any well known computer language, such as, for example, the hypertext mark-up language (HTML), Java server pages (JSP), the extensible mark-up language (XML), etc. and may be communicated via well known communications protocols, such as, for example, the hypertext transfer protocol (HTTP). Server communications and transactions may be supported by secure HTTP (S-HTTP), secure sockets layer (SSL) encryption, and other well known and/or priority security techniques.

To maintain information about the members of the program, about purchase transactions, about bank account balances, about merchant participation fee deposits, and the like, one or more databases may be included in the RPC and stored on storage device 110, such as, for example, member database (MDB) 114. These databases may be relational, may be programmed using the structure query language (SQL), or may be constructed according to any well known database languages and techniques.

Processor 104, memory 106, storage device 110, video controller 130, USB controller 122, and NIC 120 are coupled to one another via and communicate with one another over bus 136. Bus 136 may be any bus that provides for communication of and between components within a computer. Although only one bus is depicted, multiple buses may be used in computer 102. In addition, other components and controllers (not depicted) and multiple instances of depicted components and controllers may be included in computer 102.

The RPC may include a single computer, such as computer 102 as shown, or may include multiple computers arranged as a group, cluster, subnetwork, local area network (LAN) or other group of multiple computers. The RPC may also include other well known devices, such as, for example, gateways, bridges, routers, firewalls, etc. which may be included in a computer network environment. So as not to obscure the focus of the description, these and other well known devices are not depicted.

In various embodiments, each of merchants' computers 150, bank computer 160, auditor computer 165, travel agents' computers 170, unaffiliated third party's computer 155 and customer service center computer 190 and may be a server computer similar to computer 102, a group of computers including, for example, a subnetwork, cluster, LAN, etc, or may be a single personal computer. Buyers' computers 140 are computers of individuals who may be affiliated with a member entity such as business 144, an association, a club, a group, a municipality, a government agency, a sole practitioner and the like. Buyers' computers 140 are typically personal computing devices having components similar to those described regarding computer 102. In addition, buyers' computers 140 may be any computing device, such as, for example, personal computers, portable computers, laptop computers, computing tablets, set-top boxes, cellular telephones, personal digital assistants (PDAs) and the like. While as discussed below, it is contemplated that buyer may choose to initiate purchase over the WAN 180, in one embodiment, the rewards program is expected to accommodate any common form of purchasing of goods and services. Thus, reward points would be earned in face to face transactions, telephone orders or any other conventional transaction format. Accordingly, it is not necessary for buyer to change their buying habits to obtain at least some of the advantages of the rewards program, assuming of course, they are already purchasing from a participating merchant.

In one embodiment, each of the merchants' computers 150, bank computers 160, auditor computer 165, travel agents' computers 170, customer service center 190, RPC 100 and business 144 may communicate and transfer data over WAN 180. In some embodiments, some of these entities may communicate with one another directly. For example, auditor computer 165 may have a direct connection to bank computer 160 and the unaffiliated third party's computer 155. The direct connection may be made by leased line, dial up connection and the like. In some cases, the bank may service the unaffiliated third party.

In various embodiments, kiosk 175 may be connected to the WAN 180. The kiosk are effectively dedicated hardware remotely distributed to permit members to access the RPC 100. The kiosk may include a general purpose computer with appropriate resident software, which in one embodiment may permit establishment of a virtual private network between the kiosk 175 and the RPC 100. The kiosk may employ any one or more of touch screen technologies, magnetic card reading, a speech recognition interface, infra red signaling interface or radio frequency signaling interface between the kiosk and e.g., a smart card, etc. Various authentication technologies such as PINs and passwords may be used to improve security.

Customer service center 190 may be maintained by the reward program administrator and may provide support to participating buyers, sellers, travel agents and banks. The customer service center may provide access to information concerning all aspects of the reward program, including bank account balances, travel reservation information, purchase history, participation fee history, etc. The customer service center may be accessible by computer via the Internet, and may be accessed via telephone such that human operators may provide the information requested by referring to computers connected with the RPC.

The RPC may provide various interfaces to each of the participating entities in the reward program system. The reward program center may provide a web site with various web pages that allow member businesses to access information concerning the reward program. For example, the RPC may provide an Internet web interface by which the individuals may, depending on their authorization level, view the current balance in the member business reward bank account, view all recent transactions with participating merchants within a specified time frame, view authorized travel reservations, view currently pending travel payment requests, etc. The web site interface may also allow authorized individuals of member businesses to approve or otherwise authorize an unaffiliated third party to transfer funds from the business reward bank account to a trust account specified by the travel agent to make payment for travel reservations made by one or more individuals of the member entity. Travel reservations include, without limitation, airline travel, car rental, hotel booking, restaurant reservations, or any other goods or services typically offered by a travel agent.

Other interfaces that are more low level may be provided to each of the merchants, travel agents, and banks. In this way, various data concerning the transactions involved in the reward program system may be communicated, and electronic fund transfers may be made and/or facilitated. More specifically, a merchant interface may be configured to receive transaction reports from participating merchants whenever member buyers make purchases from the merchant. A travel agent interface may be configured to receive travel reservation notices from nominated travel agents regarding travel reservations made by individuals affiliated with member business and to provide fund transfer notices to nominated travel agents. A bank interface may be configured to receive member account summaries and merchant deposit summaries on a regular basis from a participating bank. The bank interface may also be configured to allow the RPC to forward travel payment requests made by authorized individuals from member businesses which instruct the unaffiliated third party to transfer funds from a member rewards bank account to the trust bank account of a nominated travel agent. An unaffiliated third party interface may forward a travel payment request to the unaffiliated third party. Each of these interfaces may be secured by well known encryption and other methods to provide for safe transfer of sensitive information between each of the participants.

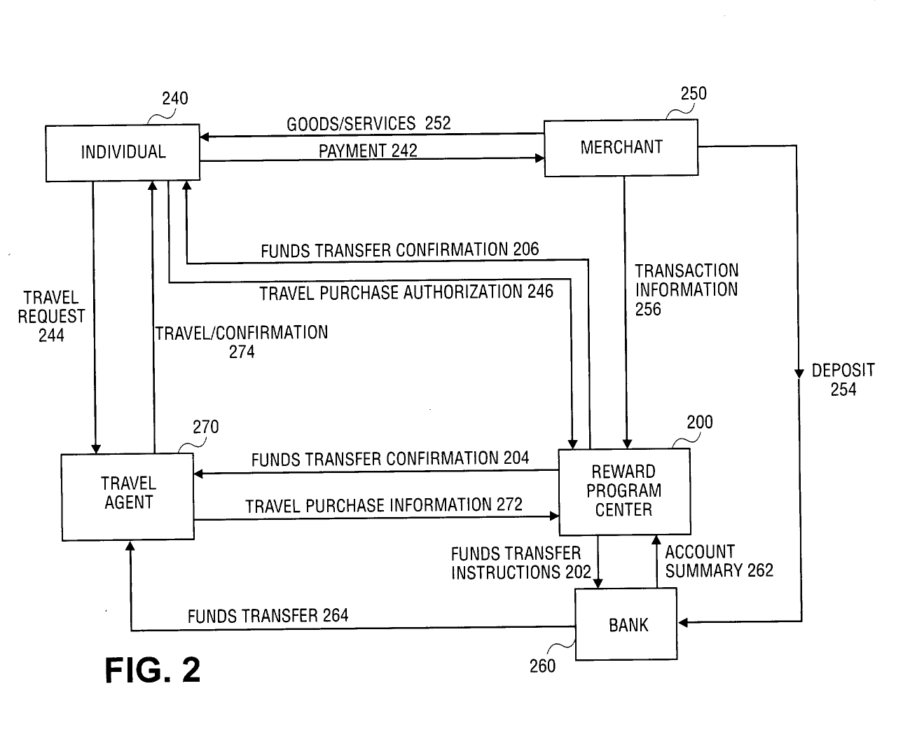

FIG. 2 illustrates the transactions between participants in the reward program methods and systems described herein. According to the systems and methods described herein, an individual 240 of a member business may provide an identification number along with a payment 242 to a participating merchant 250 to obtain goods or services 252. The participating merchant then makes a deposit 254 of a participation fee based on the monetary value of the sale, which may also be referred to as a commission, into a bank account in bank 260. In one embodiment, this bank account is a temporary holding account into which all merchant deposits are made. The deposit, in one embodiment, includes various tracking information such as the identification number for the individual making the purchase, a business identifier, and other pertinent information. Merchant 250 also provides transaction information 256 to reward program center 200. In one embodiment, the transaction information includes the identification number of the individual making the purchase, a textual or other identification of the goods and/or services purchased by the individual from the participating merchant, the amount of the payment made by the individual, and the amount of the participation contribution deposited by the merchant into the temporary holding area bank account. In various embodiments, not all of this information may be required as part of the transaction information, and/or additional transaction information may be provided.

In various embodiments, the RPC 200 may receive from the bank and/or from the auditor a nightly account summary 262 of all deposits made into the temporary holding area bank account; the account summary may also be provided by the bank, unaffiliated third party and/or auditor upon request of the RPC 200; and may be provided on a regular basis such as hourly, four times a day, or immediately upon the receipt of deposits, or immediately when a system defined balance has been exceeded, or according to any other desirable scheme. The RPC 200 may reconcile the transaction information 256 with the deposit information received in account summary 262 to ensure that the proper participation fee is being paid by participating merchants. The RPC 200 updates its internal databases based on the transaction information and the account summary.

To obtain travel using the member rewards bank account, individual 240 associated with a member may contact, in any traditional means, a travel agent 270 and make a travel request 244, such as a flight reservation, a hotel reservation, a car rental reservation, etc. When presenting the travel request to the travel agent, the individual must provide the individual's reward program identification number so that payment for the travel may be transferred from an appropriate business' member rewards bank account. In one embodiment, the travel agent 270 may send travel purchase information 272 to the RPC 200. In another embodiment, the reward program center may refer to and/or provide access to a third party travel reservations web site. Upon making a travel request, the individual is provided a record locator or other travel request identifier by the travel agent to identify the particular travel reservation. The individual uses the travel request identifier to authorize payment of the travel reservation from the member rewards bank account through an unaffiliated third party via RPC. The individual makes a travel purchase authorization 246 with the RPC 200, which causes the RPC 200 to forward funds transfer instructions 202 to an auditor and/or bank 260 to transfer reward program dollars from the business' member rewards bank account to a trust account of the travel agent, as shown by funds transfer 264. The RPC 200 may send a funds transfer confirmation 206 to the authorized individual and also send a funds transfer confirmation 204 to the travel agent.

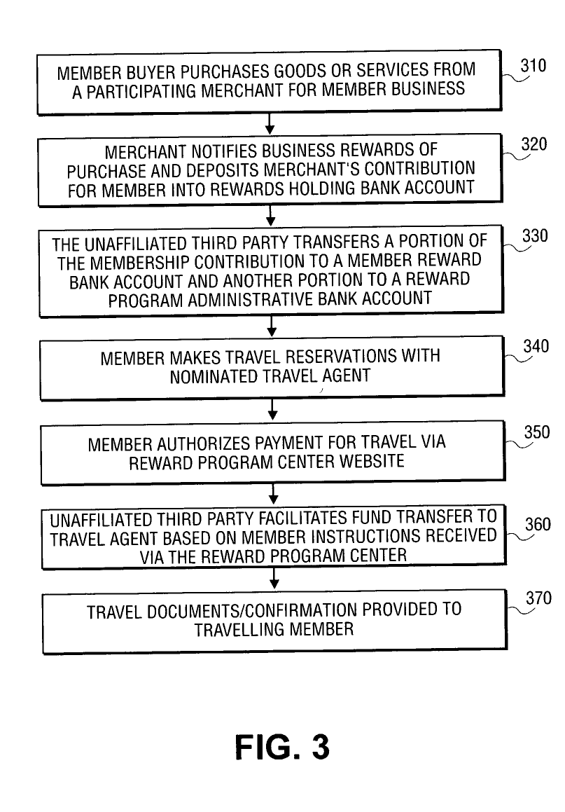

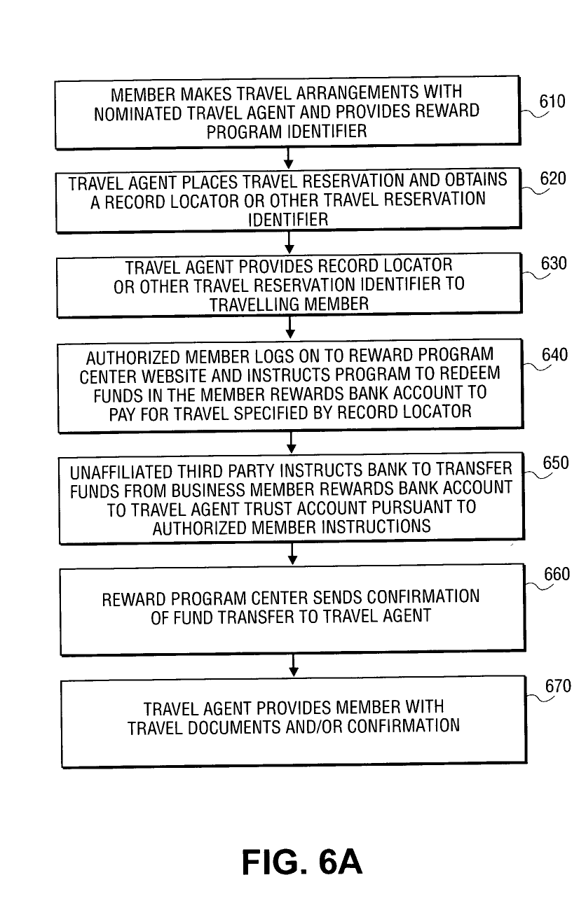

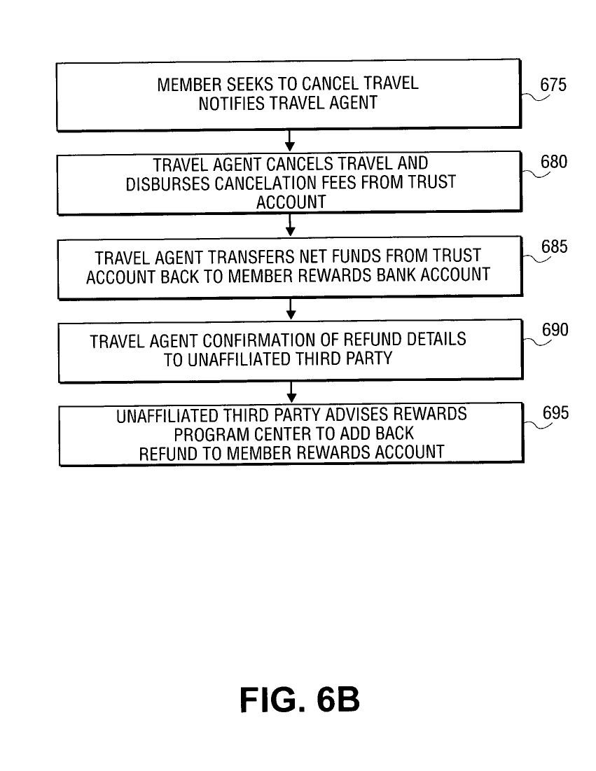

FIG. 3 illustrates a generalized flow of actions taken by participants according to the reward program methods and systems described herein. A member buyer, also referred to as an individual affiliated with a member business, purchases goods or services for the member business from a participating merchant, as shown in block 310. The merchant notifies the reward program center of the purchase and deposits a participation contribution in a temporary holding bank account, as shown in block 320. In one embodiment, an unaffiliated third party transfers a portion of the participation contribution to a business member reward bank account and another portion to the reward program administrative bank account, as shown in block 330. In another embodiment, the bank may do this automatically based on initial instructions provided when the bank accounts were opened. An individual affiliated with the member business may make a travel reservation with a nominated travel agent, as shown in block 340. In one embodiment, only a single travel agency is nominated for a geographic region. The individual may authorize payment for travel via a reward program center web site, as shown in block 350. Depending on the authorization level and privilege level of the individual who made the travel reservation, the same or another individual of the member business may be required to authorize the transfer of funds to pay for travel. The unaffiliated third party facilitates fund transfer from reward program bank account to the nominated travel agent based on member instructions received via the reward program center, as shown in block 360. In one embodiment, this facilitation may be a simple pass through of the authorization request made by the authorized individual. The travel agent, upon learning of the fund transfer, may provide travel documents to the individual that placed the travel reservation, as shown in block 370. The process in the event the member requests a refund is discussed below in connection with FIG. 6B.

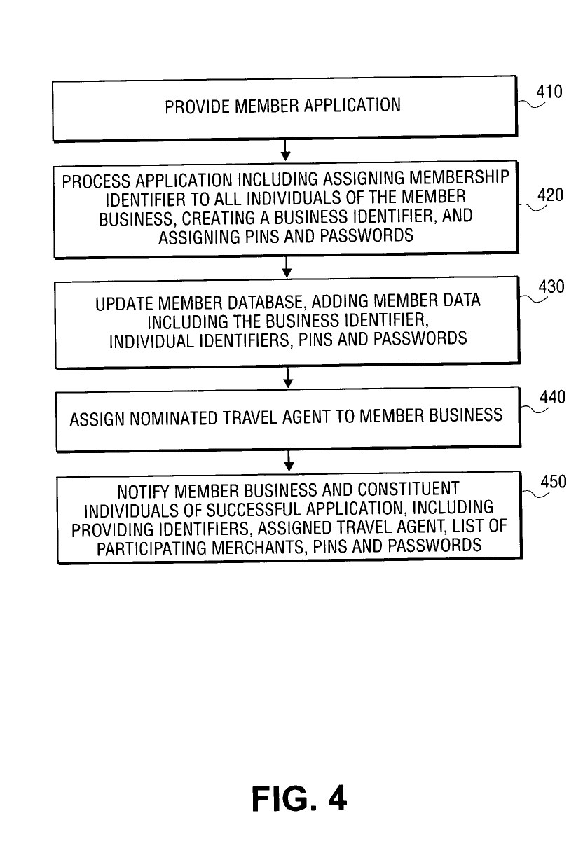

FIG. 4 illustrates the flow of actions taken when a business registers to become a member of the reward program according to the methods and systems described herein. The reward program center provides a member application to a prospective member business, as shown in block 410. In one embodiment, an application may be sent in the mail, in another embodiment, an application may be provided in electronic form on a web site. In one embodiment, the member application may be in a well known format such as a portable document format (PDF) which is downloadable by the applicant from the reward program web site. The application may include specification of individuals, contact information such as mailing address, phone number, email address, as well as designation of authorization levels of each of the individuals, such as those allowed to approve travel purchases. The reward program center receives and processes the member application, including assigning membership identifiers to all individuals specified in the application, creating a member business identifier, and assigning personal identification numbers (PINs) and passwords or other access codes, as shown in block 420. For larger businesses, different levels of access to data stored by the reward program center and different authorization levels may be designated and assigned at this time. The reward program center updates the member database, adding member data including the member business identifier, the individual identifiers, PINs, and passwords, as shown in block 430. A travel agent is assigned to the member business, as shown in block 440.

Upon successful registration, the reward program center notifies the member business and, in some embodiments, constituent members, of a successful application, including providing identifiers for the individuals of the member business, the assigned travel agent, and, in some embodiments, a list of participating merchants, as shown in block 450. In addition, in some embodiments, the passwords and PINs of each of the individuals included in the membership application may also be provided. In one embodiment, the notification may be made by mailing membership cards having an identification number printed thereon to the member business. In addition to or in place of mailed notification, email notification may be sent to individuals affiliated with the member business, providing a login name to the reward program web site, a temporary password and an identification number. In one embodiment, the password, login identification number, customer identifier, etc., are sent as separate e-mails for additional security. In another embodiment, during an initial login of an individual of the member business on the reward program center web site, the individual may select a password, or replace a default password with an individual selected password. From this point forward, purchases made on behalf of the member business by individuals should be made with the reward program identification number, so that reward dollars are earned for every business purchase that is made from participating merchants. In one embodiment, purchases may be made by presenting and sliding a membership card through a card reader to identify the transaction as a reward program transaction. In yet another embodiment, when presenting a reward program card, a PIN may be requested such that payment is authorized for the goods/services by access to an account or purchase method defined in a member database entry for the business member. This may be implemented using electronic point of sale funds transfer (EPOS) techniques such that the membership card may serve as a debit card, credit card, or have similar effect.

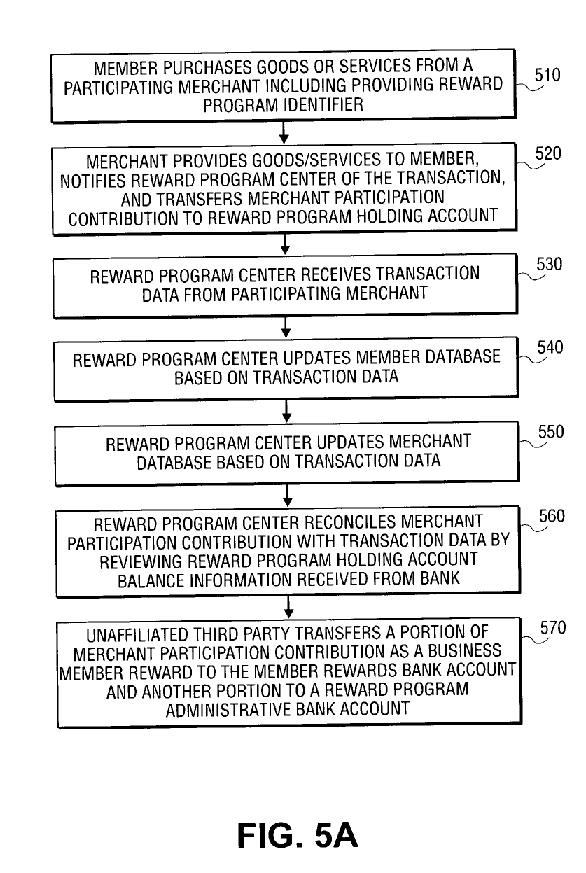

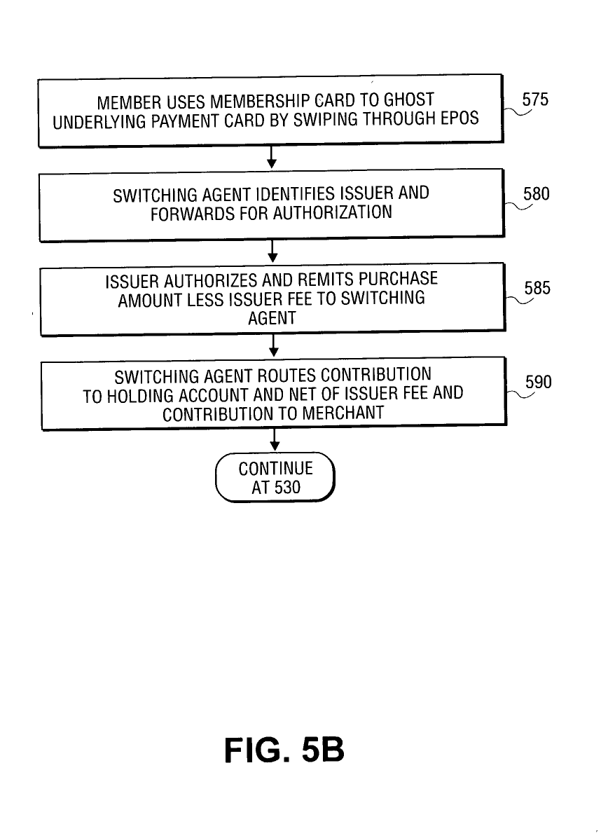

FIG. 5A illustrates the flow of actions taken when an individual of a member business makes a purchase from a participating merchant according to the reward program methods and systems described herein. An individual affiliated with a member business purchases goods or services from a participating merchant including providing the individual's reward program identifier, as shown in block 510. The participating merchant provides the goods and services to the individual or to the member business, depending on the kind of purchase, notifies the reward program center of the transaction, and transfers a merchant participation contribution to a designated reward program holding bank account, as shown in block 520. The reward program center receives the transaction data from the merchant, as shown in block 530. The reward program center updates one or more of its various databases based on the transaction data, including the member database, the participating merchant database, and possibly other databases, as shown in block 540. The reward program center updates the merchant database based on the transaction data, as shown in block 550. The reward program center reconciles the merchant's participation contribution with the transaction data by reviewing reward program holding account balance information received from the bank, unaffiliated third party and/or auditor, as shown in block 560. The unaffiliated third party transfers a portion of the merchant participation fee as a business member reward to a business' member rewards bank account and transfers another portion of the merchant's participation fee to a reward program administrative bank account, as shown in block 570. In one embodiment, any deposits made by a participating merchant to the designated bank account may, every evening, for example, automatically be divided by the unaffiliated third party into reward program designated percentages, that is, in the appropriate proportions, and distributed by the unaffiliated third party to the member business reward bank account and the reward program administrative bank account. To achieve this automatic distribution, the participating merchants may include a merchant identifier and the business member identifier when making the deposit such that the unaffiliated third party may accurately maintain a ledger of funds in the member rewards bank account and appropriately divide and transfer the administrative component to the reward program administrative account based on the appropriate proportions for the particular merchant and/or business member.

FIG. 5B is a flow diagram showing routing of funds in an electric point of sale funds transfer according to one embodiment of the invention. A member may have a membership card that is associated with a payment card such as a conventional credit or debit card. By swiping that card which ghosts (or substitutes for the payment card with or without knowledge of the issuer) at the time of the transaction the member initiates an electronic point of sale funds transfer (EPOS) based on the payment card, at block 575. At block 580, a switching agent identifies the issuer of the underlying payment card and that the transaction is subject to rewards credit and forwards the information to the issuer for authorization. At block 585, the issuer authorizes the transaction and remits the purchase amount less the issuer fee to the switching agent. For example, if the transaction is for $100 and the issuer fee is $2, the switching agent would receive $98. Then at block 590, the switching agent sends the participation contribution with the appropriate identifying information to the program holding account for distribution by the unaffiliated third party and remits the net of the issuer fee and participation contribution to the merchant. Continuing the prior example, if the contribution is 10%, $10 would arrive in the holding account and $88 would go to the merchant. The subsequent accounting follows as described above with reference to FIG. 5A.

In one embodiment, the reward program holding bank account is created by an unaffiliated third party pursuant to instructions received from the reward program administrator. This account is only accessible by and is controlled by the unaffiliated third party. In this way, merchant participation fees received into the reward program holding bank account are divided according to agreements reached between the reward program administrator and participating merchants by the unaffiliated third party, and/or automatically by the bank under the supervision of the unaffiliated third party. This watchful eye adds confidence to reward program participating merchants and business members that funds are being transferred, credited and awarded properly. As used herein, the term “unaffiliated third party” is deemed to include any third party whose actions are audited independently of the buyer members, participating merchants, the nominated travel agent and the rewards administrator.

FIG. 6A illustrates the flow of actions taken when purchasing travel from a nominated travel agent according to the reward program methods and systems described herein. An individual affiliated with a member business makes travel arrangements with a nominated travel agent, including providing the individual's reward program identifier, as shown in block 610. The travel agent places the travel reservation and obtains a record locator or other travel reservation identifier, as shown in block 620. The travel agent provides the record locator or other travel reservation identifier to the travelling member, as shown in block 630. An authorized individual of a member business may log on to the reward program center web site to instruct the reward program to redeem funds in the member rewards bank account to pay for travel specified by a record locator supplied by the member, as shown in block 640. The unaffiliated third party instructs or otherwise facilitates the bank's transfer of funds from the member rewards bank account to a travel agent trust account, as shown in block 650. The reward program center may send a confirmation of funds transfer to the travel agent, as shown in block 660. The travel agent provides the individual who will be traveling with necessary travel documents and/or confirmation that the travel reservation has been funded, as shown in block 670.

The methods described regarding FIGS. 4, 5 and 6A may be supported via an Internet web site provided by the reward program. In one embodiment, authorized individuals may log in according to well known methods to check on the balance in the member reward bank account. In addition, tracking, monitoring and other accounting functions may be provided regarding purchases made from participating merchants and nominated travel agents. This information may be provided in real-time to authorized individuals immediately upon receipt and processing of transaction information, travel purchase information, and bank account summaries received electronically from those participating merchants, unaffiliated third party, bank, and nominated travel agent.

FIG. 6B is a flow diagram illustrating flow in the event that a member seeks to cancel travel previously booked through the rewards program. The member notifies the travel agent of the desire to cancel travel, provides the relevant confirmation such as the record locator, etc., at block 675. At block 680, the travel agent cancels the travel and disburses any cancellation fees or related service charges from the trust account to the relevant travel provider and/or the travel agent's account depending on the then applicable cancellation policy. Then at block 685, the travel agent transfers funds from the trust account back to the member rewards account using the appropriate member number to ensure proper credit within the member rewards account. This refund policy prevents circumnavigation of the rewards program by booking and canceling travel. At block 690, the travel agent sends a confirmation of refund details to the unaffiliated third party for appropriate credit in the member rewards account. Finally, at block 695, the travel agent notifies the RPC to add back the refund to the business' member rewards account.

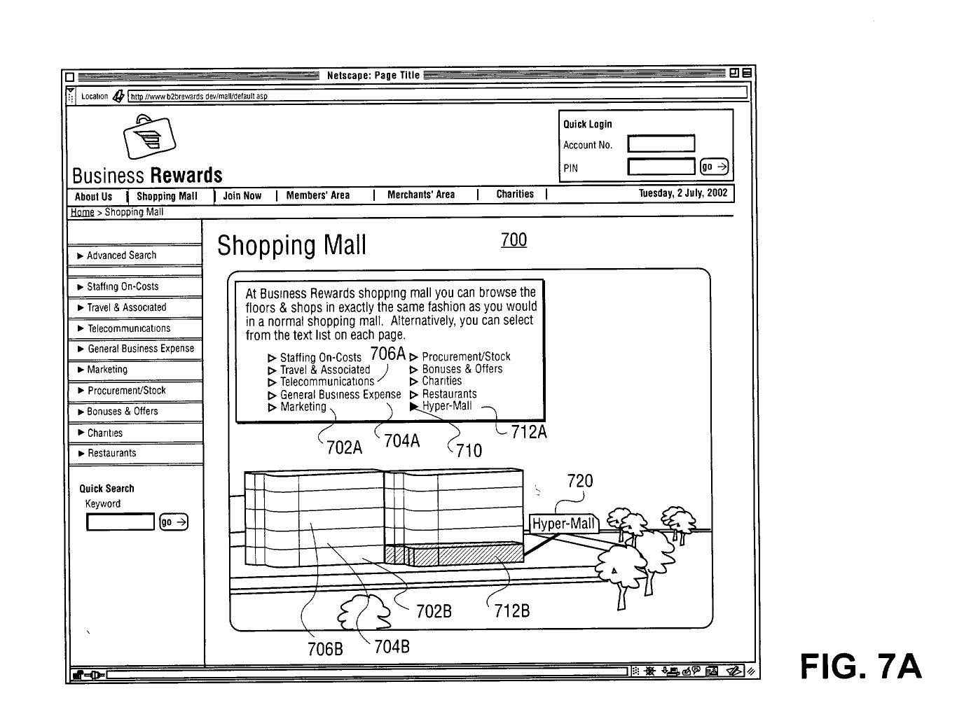

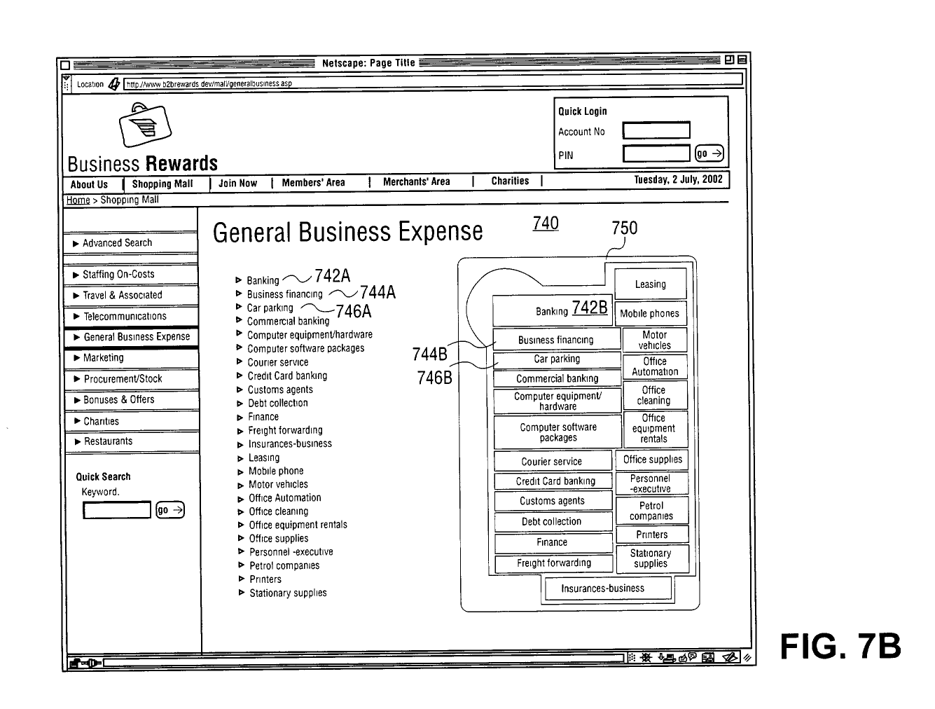

FIGS. 7A and 7B illustrate an embodiment of a virtual merchant mall. In one embodiment, a mall interface may be provided to reward program members. The mall interface may present a graphical depiction of a shopping mall, referred to as virtual mall 700. The virtual mall may, in one embodiment, display store names superimposed on the virtual mall. In another embodiment, the virtual mall may be organized into departments or categories such that a kind of good or service to be provided is displayed as by text such as, for example, “General Business Expense” 704A, “Payroll” 704, “Telecommunications” 706A, “Marketing” 702A. In another embodiment, the kind of good or service may be defined as a readily cognizable graphic icon, thumbnail, etc. When traversing the various departments, when a text item such as Hyper-Mall 712A is traversed or passed over, it may cause a designator 710 to activate and a corresponding portion of a graphical rendering of a virtual building such as portion 712B to activate by highlighting and creating a walk out label 720 which also states Hyper-Mall. Similar actions occur for 702A, 704A, 706A, 702B, 704B and 706B. When a walk out label is clicked on or otherwise activated a more detailed web page is provided.

When the text or icon of a department is clicked on, the kind of stores that make up the contents of the department may be provided. The floor may include text labels for various kinds of merchants such as “Banking” 742A, “Business Financing” 744A, and “Car Parking” 746A, among others. Similarly, those portions of a virtual building 750 may be activated to go to a particular merchant web site, such as by clicking on “Banking” 742B, “Business Financing” 744B, and “Car Parking” 746B.

When a member that is logged on to the web site clicks on a store or merchant in the virtual mall, the member may be redirected to the web site of the participating merchant. The member may then shop for and make purchases to earn rewards.

In one embodiment, the member may receive a greater reward for making purchases from participating merchants after connecting to the merchant's web site via the reward program virtual mall. For example, a merchant may advertise that a buyer making a purchase from its web site after connecting to the reward program virtual mall may receive a 10% of purchase reward, while telephone and facsimile orders may only result in the receipt of an 8% reward. The same increased award may be provided for Internet based purchases regardless of whether they initiated in the reward program virtual mall. In these embodiments, the reward program is not providing fulfillment or any order processing; the reward program web site is merely providing an interface through which buyers may connect with sellers; it is the sellers' web sites that service the buyers' orders.

In one embodiment, a Hyper-Mall is provided to permit those merchants without an established Internet presence to participate in e-commerce activities without the typical upfront costs associated with creating such a presence. In the Hyper-Mall, merchants are able to rent space in a manner metaphorically similar to renting of space in a brick and mortar mall. However, in one embodiment, the virtual retail space is configured the same for all merchants such that the presentation, indexing and so forth is consistent from one to the next within the Hyper-Mall. The Hyper-Mall landlord maintains a database and front end interface for the merchants and customers in the Hyper-Mall as well as hosting the relevant data. Thus, a database is provided and maintained by the Hyper-Mall landlord in which merchants may store product listings, prices, etc., related to their offering through the Hyper-Mall. This is at odds with traditional virtual malls that effectively sell advertising space and merely provide a hyper link to the merchants existing site. Within the Hyper-Mall, order fulfillment remains the merchants responsibility, but the e-commerce payment and execution may be out sourced to a single contractor such as one engaged by agreement with the Hyper-Mall landlord. User ease is improved because a consistent interface may be provided for the diverse goods or services sold through the Hyper-Mall. Moreover, this provides e-commerce access independent of the scale of the underlying operator. In one embodiment, within the Hyper-Mall, commonality of presentation of the different merchant's goods and services will allow members to review, select and order far more efficiently than other embodiments of the shopping mall on the Internet. The same factors will save merchants considerable development, listing, maintenance, update and service fees which will allow them to offer increased contributions to the business rewards program.

In one embodiment, the reward program may create and host the Hyper-Mall. While contracting out e-commerce transaction processing a third party such as a bank. Rent for this space in the Hyper-Mall may be paid by an increased merchant participation fee, be based on required storage space in the RPC database, cost of goods sold, units sold and by other techniques. In one embodiment, the merchant is provided access to at least their section of the Hyper-Mall database so they can update product listings, pricing, etc. In this embodiment, the merchant provides order/service fulfillment, while the reward program creates and hosts the sites. In other embodiments, the reward program may provide these services by directing the merchant to participating exclusive reward program web site designers, web hosting companies, e-commerce providers, etc.

Participation in the reward program may be desirable to a merchant that wishes to increase its Internet sales without expending resources on its own extensive marketing campaign. That is, by participation in the reward program, including inclusion in the virtual mall and providing increased rewards to member businesses that make purchases via the Internet, merchants may increase their Internet derived revenue without investing in outside marketing or advertising.

As an added feature, in one embodiment, the reward program center web site may run internal analysis of member's purchase histories to determine how the member business may better utilize the reward program. For example, if no telephone service purchases are included in a member's purchase history, the reward program center may provide an alert to authorized individuals when logging on to the reward program center web site. The alert may be provided in a designated alert web page, web page frame, or according to other well known techniques. The alert may suggest that the member business use participating merchants to buy e.g., telephone service or other goods and services under represented by the member's purchase history to receive a reward based on purchases which, based on a 10% reward, may result in significant contribution to and resulting decrease in travel expenses.

In the foregoing specification, the invention has been described with reference to specific embodiments. It will be evident that various modifications and changes can be made without departing from the broader spirit and scope of the invention as set forth in the appended claims. For example, while the preceding description assumes that only businesses could be members of the rewards program, in one embodiment, individuals meeting certain criteria may be allowed to participate. Additionally, while the discussion above has largely assumed that rewards are used to purchase travel, in other embodiments, other classes of goods or services may be purchased via the reward program such as, for example, telecommunications, postage, shipping, insurance, etc. The specification and drawings are, accordingly, to be regarded in an illustrative rather than a restrictive sense.

What is claimed:

1. A method comprising:
establishing a network of sellers and buyers in which the buyers receive a sales based reward and the sellers pay a sales based commission to an administrator, the administrator being unaffiliated with either the buyers or the sellers;
receiving the sales based commission to be divided between a buyer component which becomes the sales based reward and an administrative component; and
depositing the buyer component into a segregated member rewards bank account such that a balance in the reward bank account is fully funded.

2. The method of claim 1 wherein establishing comprises:
registering the sellers; and
processing applications from the buyers.

3. The method of claim 1 wherein at least some of the sellers are the exclusive or preferred provider of a particular good or service.

4. The method of claim 1 wherein the member rewards bank account may solely be used to purchase travel from a nominated travel agent.

5. The method of claim 1 further comprising:
forwarding a buyer authorization to transfer a sum from the segregated member rewards bank account to a travel agent trust account to fund a buyer's travel reservation.

6. The method of claim 1 wherein the member rewards bank account is maintained by a third party unaffiliated with the administrator.

7. The method of claim 1 further comprising:
facilitating buyers purchasing goods and services from sellers by providing an Internet web site that includes a virtual mall of sellers.

8. The method of claim 7 wherein the virtual mall includes links to Internet web sites of the sellers from which the buyer may purchase goods and services.

9. The method of claim 1 further comprising:
facilitating buyers purchasing goods and services from sellers by instituting a marketing campaign targeting the buyers.

10. The method of claim 1 further comprising:
providing buying pattern analysis to the buyers based on transaction information provided by sellers.

11. The method of claim 10 wherein the providing buying pattern analysis is delivered via an Internet web site.

12. The method of claim 1 further comprising:
providing purchase recommendations to the buyers based on the buying habits of the buyers.

13. The method of claim 1 further comprising:
supplying the buyers a membership card; and
ghosting a payment card with the membership card such that rewards transaction may be directly conducted without the payment card.

14. A method comprising:
establishing a block of sellers through which buyers receive a reward based on purchases made from the sellers and the sellers pay a commission to a program administrator based on the purchases, the program administrator being unaffiliated with the buyers and the sellers; and
retaining an unaffiliated third party to process the sales based contribution by dividing the sales based contribution between a buyer component which becomes the reward and an administrative component, and to deposit the buyer component into a member rewards bank account that may only be accessed by the buyer such that a reward value is fully funded and secure.

15. The method of claim 14 wherein the member rewards bank account may solely be used to purchase travel from a nominated travel agent.

16. The method of claim 14 further comprising:
forwarding a buyer authorization to transfer a sum from the member rewards bank account to a travel agent trust account to fund a buyer's travel reservation.

17. A method comprising:
registering a plurality of members;
registering a plurality of participating merchants; and
receiving from a participating merchant a member transaction report including a financial value of purchases made by a plurality of individuals affiliated with one of the members and a deposit data specifying a participation contribution based on purchases made by the plurality of individuals affiliated with the member that was deposited in a reward program holding bank account.

18. The method of claim 17 comprising:
reconciling a bank entry in the holding bank account with the deposit data and the transaction data.

19. The method of claim 17 comprising:
retaining an unaffiliated third party to manage the reward program holding bank account, including instructing the unaffiliated third party to transfer a portion of the participation contribution from the reward program holding bank account to a member rewards bank account whenever any of the participating merchants deposits the participation contribution into the reward program holding bank account.

20. The method of claim 19 wherein retaining the unaffiliated third party further includes instructing the unaffiliated third party to debit the member rewards bank account balance based on a travel purchase made by another individual affiliated with the member entity reported by and made through a nominated travel agent.

21. The method of claim 19 wherein retaining the unaffiliated third party further includes instructing the unaffiliated third party to transfer a second portion of the participation contribution from the reward program holding bank account to a reward program administration bank account.

22. A system comprising:
a member interface to provide member rewards bank account information and member transaction information, and to receive travel payment authorization from a plurality of individuals affiliated with a member entity;
a merchant interface to receive transaction reports from a plurality of participating merchants;
a travel agent interface to provide funds transfer notices to a nominated travel agent;
a bank interface to receive from a bank member account summaries and merchant deposit summaries; and
an unaffiliated third party interface to forward the travel payment authorization to the unaffiliated third party.

23. The system of claim 22 further comprising:
a mall interface to present links to Internet web site of participating merchants.

24. The system of claim 22 wherein the member interface further provides buying habit analysis.

25. The system of claim 22 wherein the member interface further provides recommendations as to how to more effectively use the reward program.

26. A machine readable medium having instructions stored thereon which when executed by a processor cause the processor to perform operations comprising:
establishing a network of sellers and buyers in which the buyers receive a sales based reward and the sellers pay a sales based commission to an administrator, the administrator being unaffiliated with either the buyers or the sellers;
receiving the sales based commission to be divided between a buyer component which becomes the sales based reward and an administrative component; and
depositing the buyer component into a segregated member rewards bank account such that a balance in the member rewards bank account is fully funded.

27. The machine readable medium of claim 26 wherein at least some of the sellers are the exclusive or preferred provider of a particular good or service.

28. The machine readable medium of claim 26 wherein the member rewards bank account may solely be used to purchase travel from a nominated travel agent.

29. The machine readable medium of claim 26 having further instructions which when executed by the processor cause the processor to perform further operations comprising:
forwarding to an unaffiliated third party a buyer authorization to transfer a sum from the segregated member rewards bank account to a travel agent trust account to fund a buyer's travel reservation.

30. The machine readable medium of claim 26 having further instructions which when executed by the processor cause the processor to perform further operations comprising:
facilitating buyers purchasing goods and services from sellers by instituting a marketing campaign targeting the buyers.

31. The machine readable medium of claim 26 having further instructions which when executed by the processor cause the processor to perform further operations comprising:
providing buying pattern analysis to the buyers based on transaction information provided by sellers.

32. The machine readable medium of claim 26 having further instructions which when executed by the processor cause the processor to perform further operations comprising:
providing purchase recommendations to the buyers based on the buying habits of the buyers.

33. A method comprising:
providing a user interface of a virtual mall through which e-commerce activities may be conducted;
renting space in the virtual mail to a plurality of merchants; and
hosting a database storing offerings from the plurality of merchants.

34. The method of claim 33 wherein the user interface is consistant across the plurality of merchants.

35. The method of claim 33 comprising:
authorizing access to a rented portion of the database to each merchant to permit the merchant to update its offerings.

36. The method of claim 33 wherein renting space in the virtual mall requires no independent on-line presence by the merchant.

37. The method of claim 33 wherein a portion of savings achieved by the merchants from renting space in the virtual mall is distributed to members of a rewards program administered by a virtual landlord.
